(19) United States
(12) Patent Application Publication
(10) Pub. No.: US 2024/0157181 A1
(43) Pub. Date: May 16, 2024

(54) FIRE SUPPRESSION SYSTEM APPLIED TO BATTERY PACK OF ELECTRIC VEHICLE

(71) Applicant: Yong Taek MOON, Yongin-si (KR)

(72) Inventors: YongTaek MOON, Yongin-si (KR); YoungSook LEE, Yongin-si (KR); HeeJung LEE, La Crescenta, CA (US); JongGu LEE, Yongin-si (KR)

(21) Appl. No.: 18/118,569

(22) Filed: Mar. 7, 2023

(30) Foreign Application Priority Data
Nov. 10, 2022 (KR) 10-2022-0149989

(51) Int. Cl. A62C 3/07; B60K 28/14; H01M 10/48

(52) U.S. Cl. CPC A62C 3/07; B60K 28/14; H01M 10/486; H01M 50/249

(57) ABSTRACT

The present invention relates to a fire suppression system applied to a battery pack of an electric vehicle, in particular, a fire suppression system applied to the electric vehicle according to various embodiments of the present disclosure in order to accomplish the objects as described in the disclosure is described. The fire suppression system may include: an energy storage system installed inside the electric vehicle; a sensor unit provided in the energy storage system in order to acquire battery environmental information; an fire suppression unit to inject an extinguishing agent to the energy storage system; and a control unit to control an extinguishing operation of the fire suppression unit based on the battery environmental information.

### CROSS-REFERENCE TO RELATED APPLICATIONS

This application claims the priority of Korea Patent Application No. 10-2022-0149989 filed on Nov. 10, 2022, in the Korean Intellectual Property Office, the disclosure of which is incorporated herein by reference.

### FIELD OF INVENTION

The present disclosure relates to a fire suppression system for use in electric vehicles, and more particularly to a technology to provide an electric vehicle with a fire suppression system in order to respond to a fire that occurs in a battery storage system of an electric vehicle. The present disclosure provides rapid extinguishing to minimize property damage and prevent human injuries.

### BACKGROUND OF INVENTION

In recent years, in order to address the depletion of fossil fuels such as coal and petroleum and the resulting environmental issues, there has been an active effort to develop new renewable energy systems that utilizes solar, wind, tidal, geothermal, etc. However, these new renewable energy resources have challenges in generating electricity on time, and in order to make the energy available when it is needed, a means for energy storage is required. For this need, an energy storage system (ESS) that integrates battery cells on a large scale has become an essential component of the new renewable energy system. The ESS is produced by densely arranging a large number of unit battery cells to form a battery module, which is then arranged in a large quantity in a limited space.

In general, there is an urgent need for an alternative energy source in vehicle applications, and researches in electric vehicles using electricity as a clean power source without pollution are being actively performed. Such electric vehicles are equipped with not only a drive motor to power the vehicle but also a high voltage ESS as an energy storage means to supply the electric power to the drive motor.

The ESS in the electric vehicle comprises a large number of lithium-ion battery cells that are densely arranged to form a module, and this integrated structure of the module may be packaged and mounted on the bottom of the vehicle.

A lithium-ion battery is a type of chemical energy storage system in which lithium ions are charged and discharged through an anode and a cathode (sometimes referred to as a positive electrode and a negative electrode), and it can be more rapidly charged than other types of batteries and also has a high output density to enable longer use. Further, it has other advantages: due to its relatively compact size, it allows reduction in weight; it does not suffer from the memory effect that reduces a driving time even if charged before completely discharged; the lithium-ion battery is eco-friendly, requiring less maintenance and repair costs.

However, compared to other types of batteries, the lithium-ion battery is more vulnerable to fire. The fire occurring in the high voltage ESS mounted on the electric vehicle is mostly caused by overheating and chemical reactions occurring inside the battery in a closed state, and can lead to the explosion of a batter module housing.

Specifically, the battery cells included in the ESS may be overheated due to various reasons. In the enclosed space of the overheated battery, an uncontrollable chemical reaction may occur and lead to a thermal runaway state, eventually causing explosion and occurrence of fire. The battery fire is mostly caused by a thermal runaway phenomenon of a battery cell, which is a chemical reaction that occurs when a highly oxidative anode and a highly reductive cathode come into contact with each other to undergo rapid self-heating. Causes of such a thermal runaway phenomenon include, for example, overcharging, over-discharging, internal short-circuit, failure of terminal contact, poor charging, mechanical shock, electrical shock, etc.

In the event of thermal runaway, the battery cell very rapidly discharges the stored energy, and with the greater amount of the charged energy in the battery cell, thermal runaway reaction will more actively proceed. A lithium-ion battery has a higher energy density than other batteries, and thus, the thermal runaway phenomenon can occur at an extremely high rate.

Fire generated due to thermal runaway can continue until all the energy charged in the battery is completely discharged, even if the oxygen required for combustion is blocked, releasing large amount of poisonous and flammable gases as well as carbon monooxide (CO), acetylene (C₂H₂) and hydrogen (H₂).

Meanwhile, in the event of a fire in an electric vehicle equipped with the ESS, it may be difficult to completely extinguish the fire. Specifically, numerous cells of the lithium-ion battery for an electric vehicle is packaged and then installed in an exclusive frame on the bottom of the electric vehicle, which can be difficult for users to access. Further, the battery is tightly sealed and thus, in case of fire, it is not easy to suppress fire using a fire extinguisher, water, sand, etc.

In other words, it is substantially impossible or difficult to control a chemical reaction inside the battery and prevent thermal runaway by directly injecting a fire extinguishing agent into the battery.

Further, when a fire occurs inside the ESS, the temperature can quickly rise to 1100° C. or more, leading to a metal fire and making initial fire suppression hard.

Moreover, the fire can rapidly spread to surrounding flammable materials and even to buildings or structures while simultaneously generating fire and poisonous gas, creating a high risk of chain explosion. In this case, it is very dangerous for a person to directly extinguish the fire.

Accordingly, when a fire occurs in the ESS, a fire-fighting effort is now focused on preventing the fire from spreading toward adjacent buildings due to explosion rather than directly extinguishing the ignited or fired battery module.

### SUMMARY OF INVENTION

### Technical Problem to be Solved

The present disclosure has been proposed to overcome the aforementioned problems, and an object of the present disclosure is to provide a fire suppression system that initially executes efficient fire suppression in response to a fire occurring in a battery storage system provided in an electric vehicle, thereby minimizing property damages and preventing human injuries.

Problems to be solved in the present disclosure are not particularly limited to the above problems, and instead, other problems not mentioned herein will be clearly understood from the following description by those skilled in the art.

An object of the present invention is to control a fire through announcement, control and transmission of threshold transformation from a vehicle to a control center, control officer or firefighter when the threshold transformation occurs, while transmitting statistical transformation values such as sensor value, threshold, physical transformation value, etc. to a head office of the automobile company or a local fire station in order to recognize and respond to the emergency situation.

A further object of the present invention is to prevent and extinguish initial fire and spread thereof while saving a life by understanding or monitoring the field in real time in conjunction with a black box, smartphone, CCTVs near the field, etc., and allowing controlled operation of a prepared extinguishing system.

### Technical Solution

In order to solve the above problems, there is disclosed a fire suppression system applied to the electric vehicle according to different embodiments of the present disclosure. The fire suppression system may include: an energy storage system installed inside an electric vehicle; a sensor unit provided in the energy storage system to acquire battery environmental information; an fire suppression unit to inject a fire extinguishing agent to the energy storage system; and a control unit to control an extinguishing operation of the fire suppression unit based on the battery environmental information.

According to an alternative embodiment, the energy storage system may include one or more battery modules, each of which consists of a plurality of battery cells, as well as a battery pack in which an accommodation space for the one or more battery modules is formed, wherein the provided battery pack includes one or more module areas containing the accommodation space in which the one or more battery modules are received separately.

According to an alternative embodiment, the battery pack may include one or more battery module insertion holes to form an insertion passage, through which each of the battery modules is positioned in the accommodation space of each module area, by switching the battery module insertion hole into at least one of an open state and a closed state, and is characterized in that, if the one or more battery module insertion hole is in the closed state, the module area is shielded against inflow of external air.

According to an alternative embodiment, the battery environmental information is information on at least one of the following: temperature, pressure, occurrence of gas leakage, or shock in relation to the battery pack, and it is characterized in that the information is created on the basis of one or more battery environmental sub-information corresponding to the one or more module areas. Further, the control unit may switch the battery module insertion holes into the open state or closed state on the basis of the one or more battery environmental sub-information, respectively.

According to an alternative embodiment, the fire suppression unit may include: one or more valve structures that inject the fire extinguishing agent to the corresponding one or more module areas; a fire extinguishing cylinder to deliver the fire extinguishing agent to each of the one or more valve structures; a gas feed unit that contains the fire extinguishing agent therein and supplies the fire extinguishing agent to the fire extinguishing cylinder; and one or more fire extinguishing agent feeding pipes to connect the one or more valve structures, respectively, to the fire extinguishing cylinder.

According to an alternative embodiment, each of the one or more fire extinguishing agent feeding pipes may include one or more shut-off (or blocking) valves, each of which is provided at one end of each extinguishing feeding pipe, in order to control whether to inject the fire extinguishing agent through each of the valve structures. Further, the control unit may control the one or more shut-off valves based on the battery environmental information so as to determine an amount of the fire extinguishing agent to be injected through the valve structures.

According to an alternative embodiment, each of the one or more valve structures may have: a body that forms an internal passage and is provided with a discharge hole having a predetermined diameter; and an spray unit that is movably provided in the internal passage and is exposed to the outside through the discharge hole, wherein the spray unit may be exposed to the outside through the discharge hole by applying a pressure to the inside of the body.

According to an alternative embodiment, the spray unit may include: a head that has a diameter corresponding to an inner diameter of the internal passage and moves up and down (or conducts a vertical movement) according to a pressure applied to the inside of the body; a lengthwise part that extends from the head in one direction and is provided with a plurality of perforations; a center hole that is formed in the lengthwise part along an inner longitudinal direction as well as the head and is connected to the plurality of perforations; and a spray protrusion that is provided at one end of the lengthwise part that is opposite the head. It is characterized in that at least a portion of the lengthwise part protrudes to the outside of the body in response to the pressure applied to the internal passage.

According to an alternative embodiment, the battery pack may include one or more circulation holes allowing inflow and outflow of air and a fire extinguishing agent moving hole that allows migration of the fire extinguishing agent to adjacent cell areas, wherein the control unit may control whether to open and close the circulation holes or the fire extinguishing agent moving hole based on the battery environmental information.

According to an alternative embodiment, the control unit is characterized in that it controls an extinguishing operation of the fire suppression unit on the basis of driving environmental information, wherein the driving environmental information is predictive information in relation to whether there is occurrence of accidents, and in particular, it may include at least one of information on velocity change or information on shock prevention.

Other concrete matters of the present disclosure will be enclosed in the detailed description and the accompanying drawings.

### Effects of Invention

According to various embodiments of the present disclosure, there is provided a fire suppression system that quickly performs fire suppression operation by sensing information related to the environment of an energy storage system in an electric vehicle. In other words, when there is a fire in relation to the energy storage system of an electric vehicle, it is possible to improve convenience and enhance stability in controlling the fire.

Effects of the present disclosure are not limited to the the effects mentioned above, and instead, such other effects not described herein will be obviously understood from the following description by those skilled in the art.

### BRIEF DESCRIPTION OF DRAWINGS

Various aspects of the present disclosure will be now described with reference to the drawings, wherein like reference numerals are used to refer to like elements throughout. In the following embodiments, for purposes of explanation, lots of specific details are set forth in order to provide overall understandings of one or more aspects. However, it is obvious that such aspects may be practically implemented even without these specific details.

FIG. 1 exemplarily illustrates an overall schematic view of a fire suppression system applied to an electric vehicle according to an embodiment of the present disclosure.

FIG. 2 illustrates a block diagram of a fire suppression system applied to an electric vehicle according to an embodiment of the present disclosure.

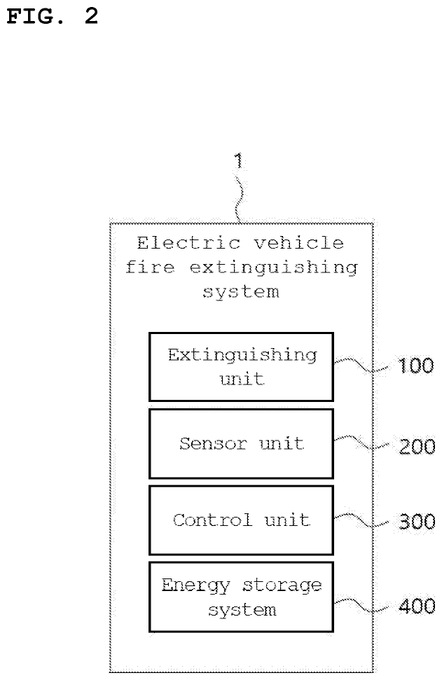

FIG. 3 illustrates a fire suppression system provided in an energy storage system according to an embodiment of the present disclosure.

FIG. 4 illustrates a process of transferring a fire extinguishing agent to each valve structure according to an embodiment of the present disclosure.

FIG. 5 illustrates a plurality of battery cells, which are shown in different directions, according to an embodiment of the present disclosure.

FIG. 6 illustrates an overall planar view of a valve structure according to an embodiment of the present disclosure.

FIG. 7 illustrates an spray unit according to an embodiment of the present disclosure.

### DETAILED DESCRIPTION OF PREFERRED EMBODIMENTS OF INVENTION

Various embodiments and/or aspects are now disclosed with reference to the accompanying drawings. In the following description, for purposes of explanation, many specific details are described to assist in the overall understanding of one or more aspects. However, it will also be appreciated by those skilled in the art, to which the present disclosure pertains, that these aspects can be practically implemented even without such specific details. The following description and the attached drawings set forth in detail certain illustrative aspects of the one or more aspects.

However, these aspects are exemplary and some of various methods in the principles of such aspects may be used, and the descriptions mentioned herein are intended to include all such aspects and their equivalents. Specifically, an “embodiment”, “example”, “aspect”, “illustration”, etc. as used herein may not to be construed as any aspect or design described being better or more advantageous than another aspect or design.

Hereinafter, the same or similar components are assigned with the same reference numbers regardless of the reference numerals in the drawings, and overlapping descriptions thereof will be omitted. Further, in describing the embodiments disclosed in this specification, detailed descriptions of related well-known technologies are omitted when it is determined that the above descriptions may obscure the gist of the embodiments disclosed herein. In addition, the accompanying drawings are only for easy understanding of the embodiments described in the present specification, and the technical spirit disclosed herein is not limited by the accompanying drawings.

Although the first, second, etc. is used to describe various devices or components, it is a matter of course that these devices or components are not limited by these terms. These terms are only used to distinguish one element or component from another element or component. Therefore, it goes without saying that the first element or component mentioned below may be the second element or component within the technical spirit of the present invention.

Unless otherwise defined, all terms (including technical and scientific terms) used in the present specification may be used as meanings commonly understood by those skilled in the art to which the present invention pertains, in addition, terms defined in the commonly used dictionary are not ideally or excessively interpreted unless clearly and specifically defined.

Moreover, the term “or” is intended to mean an inclusive “or” rather than an exclusive “or”. More particularly, unless otherwise specified or clear from context, “X employs A or B” is intended to mean one of the natural implicit substitutions. That is, X employs A; X employs B; or when X employs both A and B, “X employs A or B” may be applicable to either of the above cases. It should also be understood that the term “and/or” as used herein refers to and includes all possible combinations of one or more of the listed related items.

Further, the term “comprises (includes)” and/or “comprising (including)” should be understood to mean that the corresponding feature and/or element is present. However, it should be understood that the term “comprises (includes)” and/or “comprising (including)” do not exclude the presence or addition of one or more other features, elements and/or groups thereof. Further, unless otherwise specified or unless the context is clear as to designating a singular form, the singular form in the specification and claims should generally be construed to mean “one or more”.

When an element is referred to as being “coupled” or “connected” to another element, it may be directly coupled or connected to the other element but it should also be understood that there is any other element therebetween. On the other hand, when an element is referred to as being “directly coupled” or “directly connected” to another element, it should be understood that there are no other elements therebetween.

The suffixes “modules” and “parts” for components used in the following description are given or used in combination only considering the ease of writing the specification, and do not have meanings or roles distinguishable from each other.

When an element or layer is present “above” or “on” another element or layer, it may include not only a case where the element of layer is positioned just above the other element or layer, but also a case where there is another element or layer interposing therebetween. On the other hand, when an element is referred to as being “directly on” or “just above” another element, it means that there is no other element or layer interposing therebetween.

Spatially relative terms such as “below”, “beneath”, “lower”, “above”, “upper”, etc, may be used to easily describe the correlation between an element or component and other elements or components, as shown in the drawings. The spatially relative terms should be understood as terms including different orientations of devices during use or operation in addition to the orientation shown in the drawings.

For example, when an element shown the figures is turned over, the element described as “beneath” or “beneath” another element may be placed “above” the same (that is, another element), Accordingly, the exemplary term “below” may substantially include both directions below and above. The element may also be oriented in other orientations, and thus spatially relative terms may be interpreted according to orientation. The objects and effects of the present disclosure, and technical configurations for achieving the same will be clarified with reference to embodiments described below in detail together with the accompanying drawings. In describing the present disclosure, if it is determined that a concrete description of known functions configurations may unnecessarily obscure the subject matter of the present disclosure, a detailed description thereof will be omitted. In addition, terms to be described later are terms defined in consideration of functions in the present disclosure, and may vary according to the intention or custom of users or operators.

However, the present disclosure not limited to the embodiments disclosed below, and may be implemented in various different forms, Only the present embodiments are provided to make the present disc to complete, and to fully disclose the scope of the disclosure to those skilled in the art to which this disclosure belongs, and the present disclosure is only defined by the scope of the claims, Therefore, the definition should be made based on the contents throughout this specification,

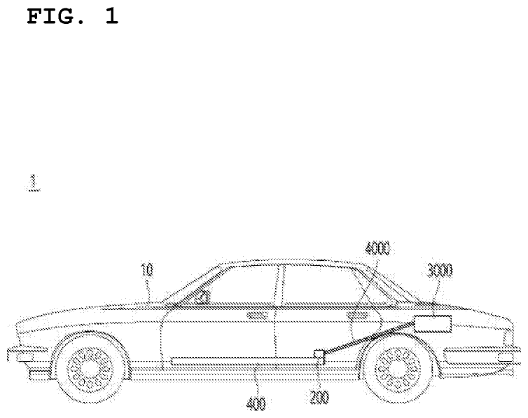

FIG. 1 illustrates an overall schematic view of a fire suppression system applied to an electric vehicle according to an embodiment of the present disclosure.

According to an embodiment of the present disclosure, the fire suppression system 1 applied to an electric vehicle may determine whether a fire occurred or not by sensing or detecting battery environmental information in relation to an energy storage system 400 installed inside the electric vehicle 10. When it is determined that the fire occurred, fire suppression efforts for controlling the fire may be conducted.

The electric vehicle 10 of the present disclosure may mean a drivable vehicle by driving an electric motor using only electric energy supplied from a charged battery cell as a power source without an internal combustion engine. When driving, the electric vehicle 10 does not use fossil fuel and thus may be eco-friendly without emitting carbon dioxide, nitrogen oxides, etc. Such an electric vehicle 10 may be driven by electric energy supplied from the energy storage system 400.

The energy storage system 400 refers to a system for storing energy and may store power of several hundreds kWh or more. Such energy storage system 400 may store the electric energy when used not much while supplying the same when it is required so as to contribute to enhancement of energy use efficiency, increase in utility of new renewable energy, and stabilization of a power supply system. For instance, the energy storage system 400 of the present disclosure relates to a storage method with storage of chemical energy and, particularly, may relate to lithium-ion battery, lead capacitor, NaS battery, or the like.

The energy storage system 400 may be configured to include a number of battery cells consisting of lithium-ion batteries. More particularly, many battery cells are gathered to form a battery module, and a plurality of battery modules are packaged in an intensive structure to configure the energy storage system 400, which in turn may be installed on the bottom of a vehicle. At this time, a lithium-ion battery is one kind of energy storage devices, in which lithium ions pass through an anode and a cathode to be charged and discharged, enabling more rapidly charging than other types of batteries and use for a long time owing to a high output density. Further, the lithium-ion battery has a relatively small volume, becomes lighter in weight, and may be more efficient since it does not have memory effects causing reduction of a driving time than the original driving time when it is charged in a state of not being completely discharged.

Although the lithium-ion battery has advantages as described above, there is a concern for occurrence of a thermal runaway phenomenon to cause a battery fire. Specifically, due to different causes such as overcharging, over-discharging, internal short-circuit accidents, failure of terminal contact, poor charging, mechanical shock, and electrical shock, the battery cells are overheated and uncontrollable chemical reaction occurs in the closed inner space of the overheated battery, which in turn leads to a thermal runaway state. The battery cell in the thermal runaway state extremely rapidly discharges the stored energy and, as the greater the stored energy in the battery cell, the thermal runaway reaction will more actively occur. In the case of the lithium-ion battery, it has a higher energy density than other batteries and the thermal runaway phenomenon may occur at a very high speed.

Meanwhile, the energy storage system 400 provided in the electric vehicle 10 may not be easily fire-controlled (that is, extinguished) using a fire extinguishing agent at the occurrence of internal fire. Specifically, as shown in FIG. 1, the energy storage system 400 is formed by packaging numerous cells of the lithium-ion battery and installed on the bottom of the electric vehicle 10, and thus a user may not easily access the same. Further, the battery of the energy storage system 400 may be provided in a closed mode, and therefore, it may not easily allow the fire extinguishing agent, water, sand, etc., to reach. In other words, it is impossible or difficult to control the chemical reaction occurred inside the battery cell and to prevent thermal runaway by directly injecting the fire extinguishing agent into the battery.

In addition, when there is an internal fire of the energy storage system 400, a temperature soars to maximally 1100° C. and it may develop into a metal fire, which in turn rapidly spreads to surrounding flammable materials and even to buildings. In this way, fire and poisonous gas are simultaneously generated to increase a risk of chain explosion. Therefore, it is very dangerous for a person to directly and manually extinguish the fire using a fire extinguisher.

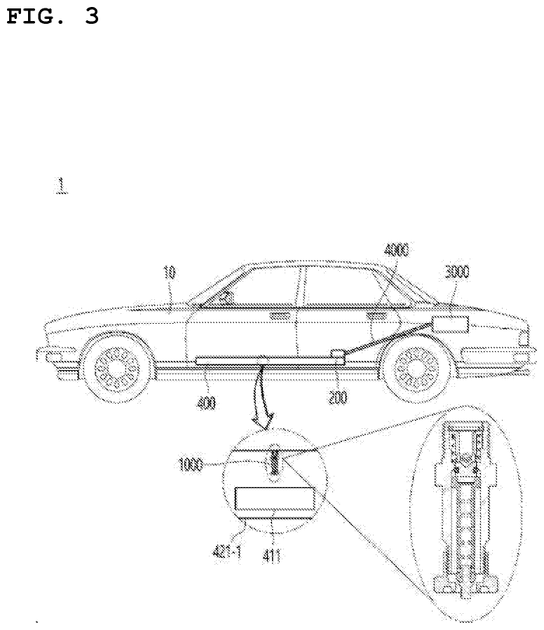

Accordingly, the fire suppression system 1 of the present disclosure, as shown in FIG. 3, may include one or more valve structures 1000 provided to corresponding different areas inside the energy storage system 400, respectively, wherein the fire extinguishing agent is injected through each valve structure 1000 at a fire to perform initial fire suppression in relation to the battery module.

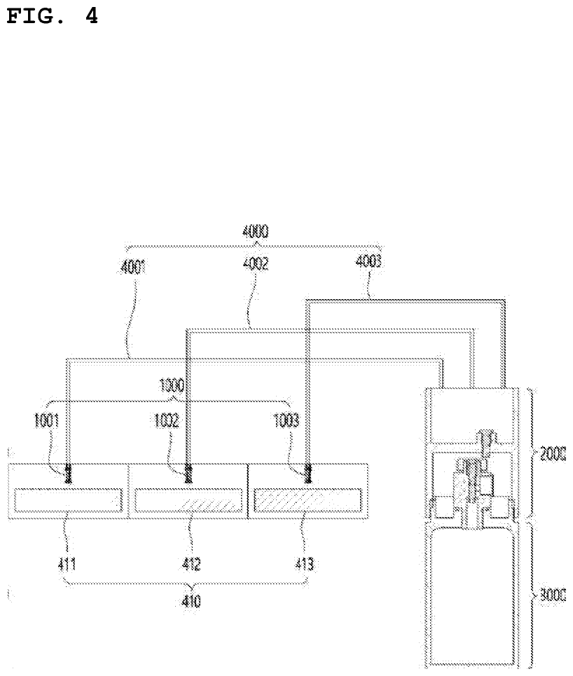

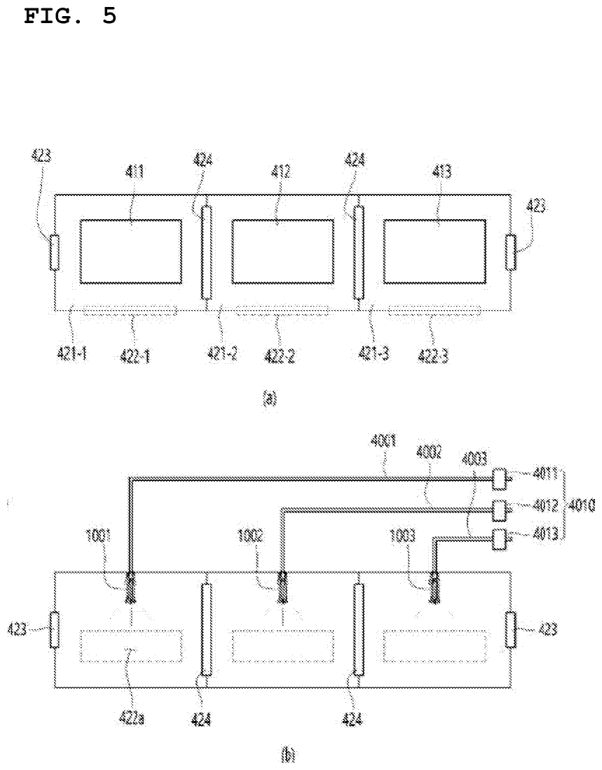

FIG. 4 illustrates a process of transferring a fire extinguishing agent to each valve structure according to an embodiment of the present disclosure and FIG. 5 illustrates a plurality of battery cells, which are shown in different directions, according to an embodiment of the present disclosure.

For example, as shown in FIGS. 3, 4 and 5, the valve structure 1000 may be provided in a first module area 421-1 at which a first battery module 411 is positioned. The fire suppression system 1 of the present disclosure may operate a fire suppression unit 100 based on battery environmental information sensed through a sensor unit 200, so that each spray unit 1200 provided in the energy storage system 400 may conduct operations for fire extinguishing, that is, initial extinguishing work.

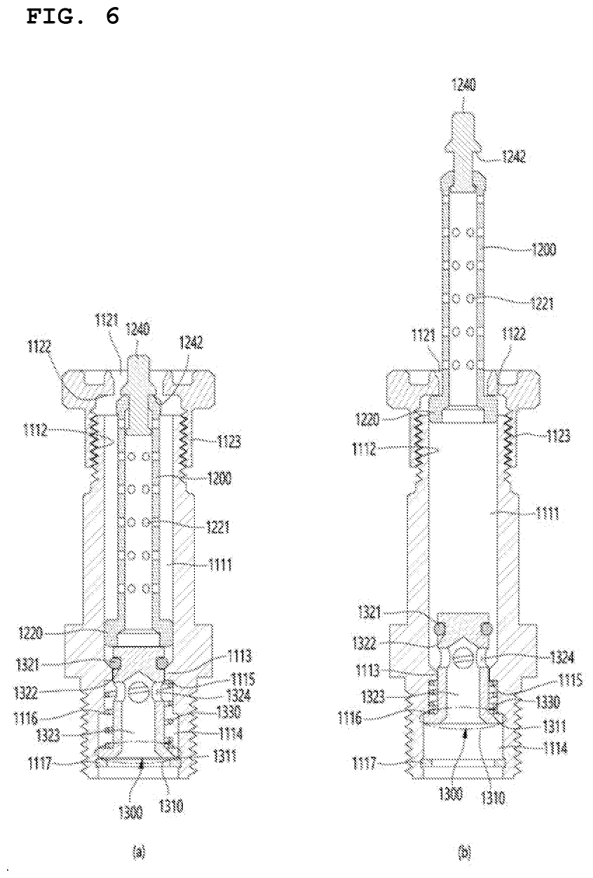

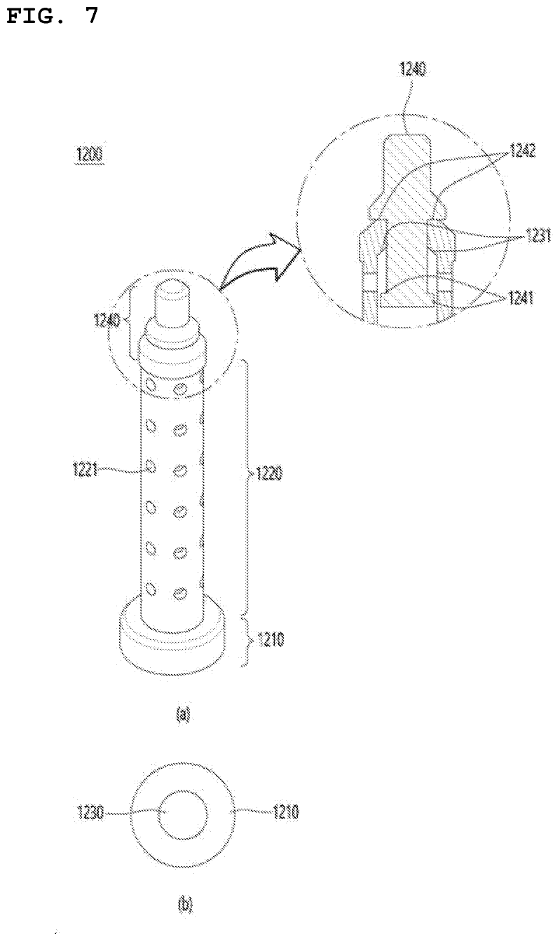

FIG. 6 illustrates an overall planar view of a valve structure according to an embodiment of the present disclosure and FIG. 7 illustrates an spray unit according to an embodiment of the present disclosure.

As shown in FIG. 7, the spray unit 1200 may include a head 1210, a lengthwise part 1220, a center hole 1230, and a spray protrusion 1240. The spray unit 1200 may include a head 1210 having a diameter corresponding to the inner diameter of the internal passage and configured to perform a vertical movement according to the pressure applied to the inside of the body.

The spray unit 1200 may also include the lengthwise part 1220 extending from the head 1210 in one direction and having a plurality of perforations 1221 formed therein. At least a portion of the lengthwise part 1220 may protrude outwardly from the body 1100 according to pressure applied to the inside of the body 1100. The plurality of perforations 1221 allowing a fire extinguishing agent to be sprayed to the outside therethrough may be formed in the lengthwise part 1220. The plurality of perforations 1221 may be connected to the center hole 1230.

The spray unit 1200 may also include the center hole 1230 longitudinally formed inside the head 1210 and the lengthwise part 1220 and connected to the plurality of perforations 1221. That is, the center hole 1230 may be formed to extend through the spray unit 1200 in the longitudinal direction of the lengthwise part 1220 and be connected to the plurality of perforations 1221.

Accordingly, the fire extinguishing agent may be supplied toward the head 1210 and then sprayed to the outside through each of the plurality of perforations 1221 via the center hole 1230.

The center hole 1230 is formed from the head 1210 through the lengthwise part 1220, and the diameter of the center hole 1230 may be smaller than the diameter of the head 1210 and the diameter of the lengthwise part 1220. In addition, the outer diameter of the head 1210 may be about the same or smaller than the diameter of the internal passage 1111 defined by the body 1100. For example, when the inner diameter of the internal passage 1111 is 2 cm, the diameter of the head 1210 may be 1.9 cm. Specific numerical values related to the aforementioned diameters are merely examples, and the present disclosure is not limited thereto.

That is, as the head 1210 of the spray unit 1200 is formed to have a diameter smaller than that of the internal passage 1111, the spray unit 1200 may perform an up and down movement (or vertical movement) according to a pressure generated inside the internal passage 1111. That is, the diameter of the internal passage 1111 may be larger than the diameter of the head 1210.

As shown in FIG. 6, the up and down movement (or vertical movement) may mean that the spray unit 1200 moves upward or downward according to the pressure inside the internal passage 1111. For example, FIG. 6-(a) may show the location of the spray unit 1200 given when a fire does not occur, that is, before the fire extinguishing unit 100 starts operating. FIG. 6-(b) may show the location of the spray unit 1200 exposed to the outside when the fire extinguishing unit 100 operates as a fire occurs.

According to an embodiment, the head 1210 may include a shock absorber configured to disperse an impact applied to the spray unit 1200. The shock absorber may be arranged on one surface of the head 1210. Referring to FIG. 6, when the shock absorber is raised in an upward direction according to the pressure, an impact caused by contact between the head 1210 and the body (i.e., the spray unit support surface 1122) may be minimized by the shock absorber formed on one surface of the head 1210. For example, the shock absorber may be formed of at least one of silicone, rubber, and urethane.

However, the shock absorber is not limited to the above-mentioned materials, and the material of the shock absorber may include various materials for dispersing, by a predetermined modulus of elasticity, a mechanical shock generated when the head 1210 and the body 1100 come into contact.

As a specific example, when a fire occurs, the fire extinguishing agent may be supplied into the internal passage 1111 of the body 1100 through the connection unit 2200, and the spray unit 1200 may be raised and exposed to the outside according to the increase in internal pressure as shown in FIG. 6-(b). In this case, the body 1100 may support the head 1210 through the spray unit support surface 1122, thereby preventing the spray unit 1200 from being completely separated from the fire extinguishing unit 100.

Here, since the exposure of the spray unit 1200 is achieved through an increase in pressure, the apparatus may be damaged due to a shock caused when the head 1210 and the spray unit support surface 1122 come into contact with each other.

Accordingly, a shock absorber formed of a cushioning material may be provided on one surface of the head 1210 that is brought into contact with the spray unit support surface 1122 when the spray unit 1200 is exposed to the outside by pressure. Accordingly, the shock caused by a contact between the body 1100 and the head 1210 may be minimized, and the stability of the apparatus may be secured. That is, damage to the spray unit 1200 or the body 1100 may be prevented by the shock absorber, and accordingly the operation efficiency of the apparatus may be improved.

The spray unit 1200 may include a spray protrusion 1240 provided at one end of the lengthwise part 1220 that is opposite the head 1210. As shown in FIG. 7, the spray protrusion 1240 may be provided at one end of the spray unit 1200 with the lengthwise part 1220 interposed therebetween.

Specifically, the spray protrusion 1240 may be provided at one end of the center hole 1230. Here, the one end of the center hole 1230 may be one end that is opposite the head 1210. In this case, a spray protrusion support surface 1231 may be provided at the one end of the center hole 1230 to prevent the spray protrusion 1240 from being completely separated from the body 1100.

As shown in FIG. 7, the spray protrusion 1240 may be arranged through the one end of the center hole 1230 to make a movement within a predetermined range limited by a spray protrusion support step 1241 and a spray surface 1242. Here, the movement within the predetermined range may mean a movement limited by the spray protrusion support step 1241 and the spray surface 1242 as shown in FIGS. 6-(a), 6-(b) and 7.

The spray protrusion 1240 may be raised by the pressure applied to the center hole 1230. When the spray protrusion 1240 is raised, a passage for discharging the fire extinguishing agent may be formed between the gap between the spray protrusion and the center hole 1230. The spray protrusion 1240 may include the spray

protrusion support step 1241 configured to contact the spray protrusion support surface 1231 formed around the center hole 1230 when the spray protrusion is raised by the pressure applied to the lengthwise part 1220. For example, when the spray protrusion 1240 is raised by the pressure applied to the center hole 1230, the spray protrusion support step 1241 may be brought into contact with the spray protrusion support surface 1231 formed at one end of the center hole 1230. Thus, the spray protrusion 1240 may be prevented from being completely separated from the spray unit 1200.

The spray protrusion 1240 may include a spray surface 1242 located above the spray protrusion support 1241 and having a step shape protruding along the outer circumferential surface of the spray protrusion. The spray surface 1242 may be provided to cause the fire extinguishing agent supplied from the center hole 1230 to be sprayed in multiple directions.

For example, when a fire occurs, the fire extinguishing agent may be supplied into the internal passage 1111 of the body 1100 through the connection unit 2200, and the spray unit 1200 may be raised and exposed to the outside according to the increase in internal pressure. The increase in internal pressure applies pressure to the center hole 1230, and the spray protrusion 1240 is raised by the pressure applied through the center hole 1230, as shown in FIG. 6-(b). When the spray protrusion 1240 projects to bring the spray protrusion support 1241 into contact with the spray protrusion support surface 1231 formed at one end of the center hole 1230, a passage for the discharge of the fire extinguishing agent will be formed through the gap between the spray protrusion 1240 and the center hole 1230.

For example, the diameter of the spray protrusion 1240 between the spray protrusion support step 1241 and the spray surface 1242 may be smaller than the diameter formed by the center hole 1230. Accordingly, the fire extinguishing agent may be discharged through the passage secured according to the difference in diameter between the spray protrusion 1240 and the center hole 1230.

The fire extinguishing agent may be discharged through the passage secured through the gap between the spray protrusion 1240 and the center hole 1230. In this case, the spray protrusion 1240 protruding through the center hole 1230 may have a smaller diameter than the center hole 1230. As the spray protrusion is fixed to the spray unit 1200 by the spray protrusion support step 1241, the spray protrusion 1240 may move at various angles with respect to the lengthwise part 1220 during the discharge of the fire extinguishing agent. Accordingly, the fire extinguishing agent may be sprayed in multiple directions.

Additionally, when the fire extinguishing agent is discharged through the passage formed as the spray protrusion 1240 rises from the spray unit 1200, the discharged fire extinguishing agent is sprayed onto the spray surface 1242 formed on the upper side of the spray protrusion 1240 and dispersed in all directions. In this case, the spray protrusion 1240 may discharge the fire extinguishing agent in various angular ranges while moving at various angles with respect to the lengthwise part 1220 during the discharge of the fire extinguishing agent. Additionally, the fire extinguishing agent may be sprayed in multiple directions by the spray surface 1242. In other words, the fire extinguishing agent may be discharged to a wider area by utilizing the spray surface 1242.

According to an embodiment of the present disclosure, the valve structure 1000 may include a control valve 1300. The control valve 1300 may be arranged in the lower passage 1114 such that at least a part thereof may be moved to the internal passage 1111 by pressure, and may control the inflow of the fire extinguishing agent into the internal passage 1111. The control valve 1300 may control the introduction of the fire extinguishing agent into the internal passage 1111 located on the upper side of the body 1100 according to the pressure caused by the fire extinguishing agent supplied through the connection unit 2200 located below the body 1100.

For example, the control valve 1300 may control the fire extinguishing agent to be delivered to the internal passage located on the upper side when the lower passage 1114 reaches a predetermined pressure or higher due to the continuous supply of the fire extinguishing agent. That is, when the control valve 1300 is subject to a pressure higher than or equal to the predetermined pressure due to the continuous supply of the fire extinguishing agent, the fire extinguishing agent may be delivered to the internal passage 1111. Here, the predetermined pressure may be based on the elastic force of a spring 1330, which will be described below.

Specifically, the control valve 1300 may include a control valve head 1310 configured to move up and down according to the applied pressure. The control valve head 1310 may be raised by the applied pressure as the fire extinguishing agent is supplied through the connection unit 2200 located on the lower side.

In addition, the control valve 1300 may include a control valve lengthwise part 1320 extending from the control valve head 1310 in one direction and having a plurality of agent discharge holes 1324. The control valve 1300 may include a control valve center hole 1323 longitudinally formed inside the control valve head 1310 and the control valve lengthwise part 1220 and connected to the plurality of agent discharge holes 1324. That is, the control valve center hole 1323 may be formed in the longitudinal direction of the control valve lengthwise part 1320 and connected to the plurality of agent discharge holes 1324. Accordingly, the fire extinguishing agent may be supplied toward the control valve head 1310 and delivered into the internal passage 1111 through the plurality of agent discharge holes 1324 via the control valve center hole 1323.

In addition, the control valve 1300 may include a spring 1330 having one end connected to one surface of the control valve head 1310 and the other end connected to an inner portion of the body 1100 to control a vertical movement of the control valve head 1310. As shown in FIG. 6, the spring 1330 may be formed in a shape surrounding the outer circumferential surface of the control valve 1300. The one end of the spring 1330 may be connected to one surface of the control valve head 1310, that is, the spring support surface 1311, and the opposite end thereof may be connected to one surface of the inwardly protruding step 1113 formed inside the body 1100, that is, to the first support surface 1115. The control valve 1300 of the present disclosure may move upward and downward by the elastic force of the spring 1330 and the pressure applied in the downward direction.

More specifically, referring to FIG. 6, the pressure applied to the control valve 1300 may be increased by the fire extinguishing agent supplied from the lower side. As the fire extinguishing agent is continuously supplied, the control valve 1300 may be raised while the spring 1330 is compressed by the pressure applied to the control valve 1300. When the control valve 1300 is raised, a portion of the control valve 1300 may move into the internal passage 1111. That is, as shown in FIG. 6-(b), the plurality of agent discharge holes 1324 may be moved into the internal passage 1111. In this case, as the spring support surface 1311 of the control valve head 1310 contacts the second support surface 1116 formed on the first body 1110, the rise of the control valve 1300 may be controlled. That is, the maximum height of rise of the control valve 1300 may be controlled by the second support surface 1116 formed on the first body 1110.

The fire extinguishing agent may be supplied into the control valve center hole 1323. Then, the fire extinguishing agent may be introduced into the internal passage 1111 through the plurality of the agent discharge holes 1121 moved into the internal passage 1111. When the supply of the fire extinguishing agent from the lower side (i.e., the connection unit) stops, the pressure applied to the control valve 1300 may be reduced. Then, the control valve 1300 is moved downward due to the resilience of the spring 1330. The plurality of agent discharge holes 1324 may return to the lower passage 1114. That is, the passage through which the fire extinguishing agent is discharged into the internal passage 1111 may be blocked.

In addition, the control valve fixing part 1117 may be provided under the control valve 1300. The control valve fixing part 1117 may protrude toward the inside of the lower passage to support and fix the control valve 1300 in the lower passage 1114. That is, the control valve 1300 may be supported or fixed at one position in the lower passage 1114 by the control valve fixing part 1117.

According to an embodiment, a packing member may be provided in a first area of the control valve 1300. Here, the first area may be an area where the control valve 1300 may contact the inwardly protruding step 1113 by the packing member 1321 when the control valve 1300 is in a lowered position (e.g., the position of the control valve in FIG. 6-(a)). Thus, the control valve 1300 may be provided with a packing groove 1322 into which the packing member 1321 is inserted. That is, the packing groove 1322 is formed in the first area of the control valve 1300, and the packing member 1321 may be arranged in the packing groove 1322. Accordingly, when the control valve 1300 is placed in the lowered position (e.g., the position of the control valve in FIG. 6-(a)), the movement of the gas (e.g., the fire extinguishing agent) may be blocked by the packing member 1321. The packing member 1321 may prevent the pressure in the lower passage from being transmitted to the internal passage 1111, and accordingly the spring 1330 may be compressed by the pressure generated by the fire extinguishing agent in the lower passage 1114. In addition, the control valve 1300 may contact the head 1210 of the spray unit 1200 when the pressure is not applied such that the pressure applied to the control valve 1300 vertically moves the control valve 1300, which in turn vertically moves the head 1210 of the spray unit 1200.

Additionally, as the packing member 1321 is provided, the gas or fluid may be blocked from unnecessarily moving from the internal passage 1111 toward the lower passage 1114 or from the lower passage 1114 toward the internal passage when the apparatus is not operating. Accordingly, the efficiency of the apparatus may be improved in terms of service life.

As described above, the technical spirits stipulated in the present invention may be implemented separately or in combination thereof.

The present invention is duly not limited to the above description, and instead, similar equivalents or variations may be possible with reference to the present invention by those skilled in the art to which the present invention pertains.

### DESCRIPTION OF REFERENCE NUMERALS

(1) Fir suppression system for electric vehicle
(10) Electric vehicle
(100) Fire suppression unit (1000) Valve structure
(1001) First valve structure (1002) Second valve structure
(1003) Third valve structure (1100) Body
(1110) First body (1111) Internal passage
(1112) Outer rotation groove (1113) inwardly protruding step
(1114) Lower passage (1115) First support surface
(1116) Second support surface (1117) Control valve fixing part
(1120) Second body (1121) Discharge hole
(1122) Spray unit supporting surface (1123) inner rotation groove
(1200) Spray (1210) Head
(1220) Lengthwise part (1221) Plurality of perforations
(1231) Spray protrusion support surface (1240) Spray protrusion.
(1241) Spray protrusion support step (1242) Injection surface
(1300) Control valve (1310) Control valve head.
(1311) Spring supporting surface (1320) Control valve lengthwise part
(1321) Packing member (1322) Packing groove
(1323) Control valve center hole (1324) Plurality of agent discharging holes
(1330) Spring (2000) Fire extinguishing cylinder
(3000) Gas feed unit (4000) One or more fire extinguishing agent feeding pipe
(4001) First fire extinguishing agent feeding pipe (4002) Second fire extinguishing agent feeding pipe
(4003) Third fire extinguishing agent feeding pipe (4010) Shut-off valve
(4011) First shut-off valve (4012) Second shut-off valve
(4013) Third shut-off valve (200) Sensor unit
(300) Control unit (400) Energy storage system
(410) One or more battery modules (411) First battery module
(412) Second battery module (413) Third battery module
(420) Battery pack (421) One or more module areas
(421-1) First module area (421-2) Second module area
(421-3) Third module area (422) Battery nodule insertion hole
(422a) Insertion passage (422-1) First battery module insertion hole
(422-2) Second battery module insertion hole (422-3) Third battery module insertion hole
(423) Circulation hole (424) Fire extinguishing agent moving hole
(424a) First fire extinguishing agent moving hole (424b) Second fire extinguishing agent moving hole

1. A fire suppression system for use in an electric vehicle, comprising:
an energy storage system (ESS) installed inside the electric vehicle;
a sensor unit provided in the energy storage system in order to obtain battery environmental information;
a fire suppression unit to discharge a fire extinguishing agent to the energy storage system; and
a control unit to operate the fire suppression unit based on the battery environmental information.

2. The fire suppression system according to claim 1, wherein the energy storage system includes:
one or more battery modules, each of which comprises a plurality of battery cells; and
a battery pack having an accommodation space to house the one or more battery modules,
wherein the battery pack is provided with one or more module areas, each of which is configured to receive each of the one or more battery modules.

3. The fire suppression system according to claim 2, wherein the battery pack includes one or more battery module insertion holes, each of which forms an insertion passage, through which each of the one or more battery modules is positioned in the module area wherein the one or more battery module insertion holes are configured to switch between an open state and a closed state, and
wherein, when the one or more battery module insertion holes are in a closed state, each of the one or more module areas is converted to prevent external air from entering the one or more module areas.

4. The fire suppression system according to claim 3, wherein the battery environmental information includes at least one of temperature, pressure, occurrence of gas leakage, or shock in connection with the battery pack, and one or more battery environmental sub-information is obtained for each of the one or more module areas, and
wherein the control unit switches between an open state or a closed state for each of the battery module insertion holes based on the one or more battery environmental sub-information.

5. The fire suppression system according to claim 2, wherein the fire suppression unit includes:
one or more valve structures to discharge the fire extinguishing agent respectively corresponding to the one or more module areas;
a fire extinguishing cylinder to deliver the fire extinguishing agent to each of the one or more valve structures;
a gas feed unit containing the fire extinguishing agent therein and configured to supply the fire extinguishing agent to the fire extinguishing cylinder; and
one or more fire extinguishing agent feeding pipes that connect the one or more valve structures to the fire extinguishing cylinder.

6. The fire suppression system according to claim 5, wherein the one or more fire extinguishing agent feeding pipes include:
one or more shut-off valves, each of which is provided at one end of each of the fire extinguishing agent feeding pipes, in order to control whether to discharge the fire extinguishing agent through each of the valve structures; and
wherein the control unit controls the one or more shut-off valves based on the battery environmental information so as to determine an amount of the fire extinguishing agent discharged through each of the valve structures.

7. The fire suppression system according to claim 5, wherein each of the one or more valve structures includes:
a body defining an internal passage and including a discharge hole with a predetermined diameter; and
a spray unit that is configured to be received in the internal passage and is movable along the internal passage to project through the discharge hole to an outside of the body,
wherein the spray unit is configured to protrude to the outside of the body through the discharge hole in response to a pressure applied to the internal passage.

8. The fire suppression system according to claim 7, wherein the spray unit includes:
a head having a diameter corresponding to an inner diameter of the internal passage and configured to move vertically in response to the pressure applied to the internal passage;
a lengthwise part extending from the head in one direction and having a plurality of perforations;
a center hole longitudinally formed through the lengthwise part and the head, and connected to the plurality of perforations; and
a spray protrusion provided at one end of the lengthwise part that is opposite the head,
wherein at least a portion of the lengthwise part is constructed to project to the outside of the body when the pressure is applied to the internal passage and then to the center hole.

9. The fire suppression system according to claim 2, wherein the battery pack includes:
one or more circulation holes allowing inflow and outflow of air; and
a fire extinguishing agent moving hole that enables the fire extinguishing agent to spread to an adjacent cell area, and
wherein the control unit controls to open or close the circulation hole or the fire extinguishing agent moving hole based on the battery environmental information.

10. The fire suppression system according to claim 1,
wherein the control unit is configured to control an operation of the fire suppression unit based on driving environmental information,
wherein the driving environmental information includes at least one of information on velocity change or shock sensing information as predictive information for occurrence of an accident.

11. A fire suppression system for use in an electric vehicle, comprising:
an energy storage system (ESS) installed inside the electric vehicle;
a sensor unit provided in the energy storage system in order to obtain battery environmental information;
a fire suppression unit to discharge a fire extinguishing agent to the energy storage system; and
a control unit to operate the fire suppression unit based on the battery environmental information,
wherein the fire suppression unit includes a plurality of valve structure, the valve structure comprising:
a body defining an internal passage and including a discharge hole with a predetermined diameter on one end of the internal passage; and
a spray unit that is configured to be received in the internal passage and is movable along the internal passage to project through the discharge hole to an outside of the body,
wherein the spray unit comprises:
a head having a diameter corresponding to an inner diameter of the internal passage that is smaller than the predetermined diameter;
a lengthwise part extending from the head and having a plurality of perforations to discharge the fire extinguishing agent;
a center hole longitudinally formed inside and through the head and the lengthwise part and connected to the plurality of perforations; and
a spray protrusion provided at one end of the lengthwise part,
wherein at least a portion of the lengthwise part is constructed to project to the outside of the body when a pressure is applied to the internal passage and then to the center hole,
wherein the spray protrusion is configured to extend from the lengthwise part to open the center hole at the one end of the lengthwise part when the pressure is applied to the center hole.

12. The fire suppression system according to claim 11, wherein the fire suppression unit includes:
one or more valve structures to discharge the fire extinguishing agent respectively corresponding to the one or more module areas;
a fire extinguishing cylinder to deliver the fire extinguishing agent to each of the one or more valve structures;
a gas feed unit containing the fire extinguishing agent therein and configured to supply the fire extinguishing agent to the fire extinguishing cylinder; and
one or more fire extinguishing agent feeding pipes that connect the one or more valve structures to the fire extinguishing cylinder.

13. The fire suppression system according to claim 12, wherein the one or more fire extinguishing agent feeding pipes include:
one or more shut-off valves, each of which is provided at one end of each of the fire extinguishing agent feeding pipes, in order to control whether to discharge the fire extinguishing agent through each of the valve structures; and
wherein the control unit controls the one or more shut-off valves based on the battery environmental information so as to determine an amount of the fire extinguishing agent discharged through each of the valve structures.

14. The fire suppression system according to claim 11, wherein the spray protrusion comprises:
a spray protrusion support step located inside the center hole at the one end of the lengthwise part and vertically movable until being resisted by a protrusion support surface on the lengthwise part; and
a spray surface located outside the one end of the lengthwise part and formed in a step shape extending along an outer circumferential surface of the lengthwise part, wherein the pressure applied to the center hole pushes the spray protrusion support step until the spray protrusion support step comes into contact with the protrusion support surface of the lengthwise part, thereby opening the center hole to discharge fire extinguishing agent that hits the spray surface to disperse in multiple directions.

15. The fire suppression system according to claim 11, wherein the body further comprises an inwardly protruding step and a lower passage provided below the inwardly protruding step,
wherein the valve structure further comprises a control valve provided in the lower passage and constructed to be at least partially moved into the internal passage, the control valve being configured to control introduction of the fire extinguishing agent into the internal passage,
wherein the control valve comprises:
a control valve head configured to perform a vertical movement in response to a pressure applied to the control valve;
a control valve lengthwise part extending from the control valve head and having a plurality of agent discharge holes;
a control valve center hole longitudinally formed inside the control valve head and the control valve lengthwise part and connected to the plurality of agent discharge holes; and
a spring, one end of which is connected to one surface of the control valve head and another end of which is connected to an inwardly protruding step, controlling a vertical movement of the control valve,
wherein the pressure applied to the control valve vertically moves the control valve so that the plurality of agent discharge holes are connected to the internal passage.

16. The fire suppression system according to claim 15, wherein the control valve contacts the head of the spray unit when the pressure is not applied such that the pressure applied to the control valve vertically moves the control valve which in turn vertically moves the head of the spray unit,
wherein the control valve further comprises a packing member that is located in the internal passage to block a leakage of the fire extinguishing agent from the lower passage to the internal passage when the pressure is not applied.

17. The fire suppression system according to claim 11, wherein the energy storage system includes:
one or more battery modules, each of which comprises a plurality of battery cells; and
a battery pack having an accommodation space to house the one or more battery modules,
wherein the battery pack is provided with one or more module areas, each of which is configured to receive each of the one or more battery modules,
wherein the battery pack includes one or more battery module insertion holes, each of which forms an insertion passage, through which each of the one or more battery modules is positioned in the module area wherein the one or more battery module insertion holes are configured to switch between an open state and a closed state, and
wherein, when the one or more battery module insertion holes are in a closed state, each of the one or more module areas is converted to prevent external air from entering the one or more module areas.

18. The fire suppression system according to claim 17, wherein the battery environmental information includes at least one of temperature, pressure, occurrence of gas leakage, or shock in connection with the battery pack, and one or more battery environmental sub-information is obtained for each of the one or more module areas, and
wherein the control unit switches between an open state or a closed state for each of the battery module insertion holes based on the one or more battery environmental sub-information.

19. The fire suppression system according to claim 17, wherein the battery pack includes:
one or more circulation holes allowing inflow and outflow of air; and
a fire extinguishing agent moving hole that enables the fire extinguishing agent to spread to an adjacent cell area, and
wherein the control unit controls to open or close the circulation hole or the fire extinguishing agent moving hole based on the battery environmental information.

20. The fire suppression system according to claim 17, wherein the control unit is configured to control an operation of the fire suppression unit based on driving environmental information,
wherein the driving environmental information includes at least one of information on velocity change or shock sensing information as predictive information for occurrence of an accident.
